(19) United States
(12) Patent Application Publication
(10) Pub. No.: US 2020/0119415 A1
(43) Pub. Date: Apr. 16, 2020

(54) ACCUMULATOR

(71) Applicant: Mahle International GmbH, Stuttgart (DE)

(72) Inventors: Ingo Haeusler, Esslingen (DE); Thomas Kalmbach, Stuttgart (DE); Christian Kern, Remseck (DE); Ruediger Knauss, Kernen i.R. (DE); Alireza Mirsadraee, Ludwigsburg (DE); Peter Nowak, Stuttgart (DE); Markus Plandowski, Stuttgart (DE); Dennis Riegraf, Balingen (DE); Karl-Ulrich Schmid-Walderich, Tuebingen (DE); Mario Wallisch, Aichtal (DE)

(21) Appl. No.: 16/597,640

(22) Filed: Oct. 9, 2019

(30) Foreign Application Priority Data
Oct. 10, 2018 (DE) 10 2018 217 319.2

(51) Int. Cl. H01M 10/6555; H01M 2/10; H01M 10/613; H01M 10/625; H01M 10/647

(52) U.S. Cl. CPC H01M 10/6555; H01M 2/1077; H01M 2220/20; H01M 10/625; H01M 10/647; H01M 10/613

(57) ABSTRACT

An accumulator may include a plurality of accumulator cells arranged adjacent to one another in a stacking direction, a plurality of cell holders for holding the accumulator cells, each cell holder holding two successive accumulator cells, and a cooling plate arranged between and in heat-transferring contact with the two successive accumulator cells.

### CROSS-REFERENCE TO RELATED APPLICATIONS

This application claims priority to German Patent Application No. DE 10 2018 217 319.2, filed on Oct. 10, 2018, the contents of which are hereby incorporated by reference in their entirety.

### TECHNICAL FIELD

The present invention relates to an accumulator, in particular for a vehicle, with several accumulator cells and cell holders for holding the accumulator cells.

### BACKGROUND

Accumulators are electrical stores, which are used for the electrical supply in a variety of applications, for example in vehicles. Generic accumulators have several electrically contacted accumulator cells which are held together mechanically in the accumulator.

Increasing requirements with regard to such accumulators, in particular the increasing need of the outputs which are to be made available by the accumulators and the associated accumulator cells, lead to the accumulators being increasingly temperature-controlled, in particular cooled. In addition, the need exists to provide such accumulators in a manner which saves installation space.

From DE 10 2003 017 355 A1 an accumulator with accumulator cells and with cell holders is known. The accumulator cells are arranged adjacent to one another in a stacking direction, wherein the respective accumulator cell is held by two cell holders which follow one another in the stacking direction. For cooling the accumulator, cooling plates are arranged in stacking direction on the end side of the accumulator. A disadvantage in such accumulators is the laborious installing of the accumulator and a low efficiency and/or a performance which is in need of improvement.

### SUMMARY

The present invention is therefore concerned with the problem of indicating, for an accumulator of the type named in the introduction, an improved or different embodiment, which is distinguished in particular by a simplified installation and/or an increased efficiency.

This problem is solved according to the invention by the subject of the independent claim 1. Advantageous embodiments are the subject of the dependent claims.

The present invention is based on the general idea of holding respectively two accumulator cells of an accumulator in a shared cell holder and of arranging a cooling plate between at least two successive accumulator cells, which cooling plate is in heat-exchanging contact with these accumulator cells. The holding of two accumulator cells by means of a shared cell holder simplifies the installation and production of the accumulator and permits a compact construction of the accumulator. The cooling plate permits an improved temperature control, in particular cooling, of the accumulator cells, so that these can be operated more efficiently, in particular can provide higher outputs. The holding of two accumulator cells by a shared cell holder allows here such cooling plates to be arranged in a simplified manner between the accumulator cells, so that the installation and production of the accumulator is, in turn, simplified.

According to the idea of the invention, the accumulator has several accumulator cells, which are arranged adjacent to one another in a stacking direction. The accumulator has, furthermore, several cell holders, wherein the respective cell holder holds two accumulator cells, following one another in stacking direction, on the accumulator. In addition, a cooling plate is arranged respectively between at least two of the successive accumulator cells, advantageously between several successive accumulator cells, which cooling plate is in heat-transferring contact with the accumulator cells. These accumulator cells therefore exchange heat with the cooling plate, in order to control the temperature, in particular to cool, the accumulator cells.

The cell holders hold the associated accumulator cells preferably transversely to the stacking direction and are preferably arranged adjacent to one another in stacking direction. Therefore, it is possible in a simplified manner to assemble the accumulator in a modular manner and in particular to provide it in stacking direction with different numbers of accumulator cells and cell holders.

The cooling plate is advantageously produced from a metal or a metal alloy, in particular from aluminium.

The respective accumulator cell can basically be formed in any desired manner. Advantageously, the respective accumulator cell has a face side facing the associated cooling plate, which has a complementary shape to the cooling plate, in such a way that the shapes correspond substantially to one another and therefore permit a structure which saves installation space, in particular is continuous.

The respective accumulator cell can basically be configured in any desired manner. In particular, the respective accumulator cell is a pouch cell which has an outer casing in which the electric cell of the accumulator cells is received.

It is further preferred if the respective accumulator cell has flat face sides facing away from one another in stacking direction. This makes possible a compact structure of the accumulator and/or an improved heat transfer between the accumulator cell and the associated cooling plate.

Advantageously, at least one of the cooling plates, preferably the respective cooling plate, is arranged between the accumulator cells which are held by a cell holder. This allows a simplified production and installation of the accumulator.

Embodiments are preferred, in which the cooling plate is produced in one piece with the cell holder holding the associated accumulator cells. The cooling plate and the cell holder are all produced monolithically, in particular in a shared production process. Advantageously, the cell holder having the cooling plate is produced from a metal or from a metal alloy and therefore has advantageous heat-conducting characteristics and an advantageous mechanical stability. In particular, the cell holder having the cooling plate is produced, in particular formed, from aluminium.

Embodiments prove to be advantageous, in which the cooling plate lies flat against at least one of the associated accumulator cells, advantageously against both associated accumulator cells. This permits, on the one hand, an improved heat transfer between the cooling plate and the accumulator cells, and leads, on the other hand, to a more compact construction of the accumulator.

An improved temperature control of the accumulator cells is achieved in that at least one of the at least one cooling plates projects at least on one side over at least one of the associated accumulator cells, advantageously both associated accumulator cells, transversely to the stacking direction. Therefore, the cooling plate exchanges heat over the projecting portion also outside the contact region with the accumulator cells. Consequently, the associated accumulator cells are temperature-controlled, in particular cooled, in an improved manner.

The respective cell holder has a holding structure for holding the associated accumulator cells on the accumulator, which holding structure can be basically configured in any desired manner.

Embodiments are preferred, in which at least one of the cell holders, advantageously the respective cell holder, has at least one nose pair with two noses, wherein the respective nose projects from the cell holder and holds the associated accumulator cell transversely to the stacking direction on the accumulator. The noses of the respective nose pair project here in opposite directions. This makes possible a simplified holding of the accumulator cells with the aid of the cell holders, and a simplified installation of the accumulator.

Embodiments are advantageous, in which the nose pair is produced in one piece, in particular monolithically, with the cell holder. Hereby, the accumulator cells can also exchange heat with the cell holder via the nose of the associated cell holder, and can therefore be temperature-controlled in an improved manner and more efficiently. When, in addition, the cooling plate is produced in one piece, in particular monolithically, with the cell holder, this leads to a further improvement of the temperature control of the associated accumulator cells.

Embodiments are advantageous, in which at least one of the noses, preferably both noses, point(s) away from the associated accumulator cell. Hereby, damage to the accumulator cells, caused by the respective nose, can be prevented or the corresponding risk can be at least reduced.

In advantageous embodiments, at least one of the cell holders has two such nose pairs, which are spaced apart from one another transversely to the stacking direction. Therefore, it is possible to hold the associated accumulator cells on the accumulator in the distance direction of the nose pairs and therefore transversely to the stacking direction in both directions.

Advantageous embodiments provide in at least one of the cell holders an outer wall which is spaced apart from the associated accumulator cells, transversely to the stacking direction, and extends along the stacking direction. This outer wall of the cell holder can function as a bearing surface of the accumulator, on/with which the accumulator is introduced in an associated application and/or is in contact with adjacent components. The spaced-apart arrangement of the outer wall with respect to the accumulator cells leads to mechanical actions onto the outer wall not, or at least not directly, leading to a corresponding mechanical action onto the accumulator cells, so that these are better protected.

The noses of the respective cell holder can run parallel to the outer wall. In alternative embodiments, the noses can also be embodied in an oblique or curved manner. Furthermore, the noses can have a constant material thickness, or can taper.

Embodiments are preferred, in which the outer wall is produced in one piece, in particular monolithically, with the associated cell holder.

A temperature control of the cell holders and/or of the accumulator cells preferably takes place directly. This means that the cell holders and/or the accumulator cells are flowed around directly by a temperature-control fluid, to which the cell holders and/or the accumulator cells transfer heat, in order to directly cool the cell holders and/or the accumulator cells.

For this purpose, the accumulator is configured such that it is flowed through by the temperature-control fluid during operation.

Embodiments are particularly preferred here, in which such a nose pair is arranged between the associated accumulator cells and the outer wall, and the outer wall is arranged spaced apart from the nose pair. Therefore, a cavity is formed between the nose pair and the outer wall, which cavity forms a channel which is able to be flowed through, which can be flowed through by a temperature-control fluid during operation, in order to achieve an improved temperature control of the accumulator, in particular of the accumulator cells. With the aid of the cell holders, therefore, not only are the associated accumulator cells held on the accumulator, but also channels are formed which are able to be flowed through for the temperature control, in particular cooling, of the accumulator cells and of the cell holders. In this way, a simple production of the accumulator is realized with an efficient temperature control and consequently an increased performance of the accumulator and/or an extended lifespan of the accumulator.

Advantageously, the respective cell holder is configured in such a way that the accumulator has several such channels, which are separated from one another in stacking direction, in particular by the adjacent cell holders.

Embodiments prove to be advantageous, in which at least two cell holders, following one another in stacking direction, have such outer walls, wherein these outer walls together form a closed outer contour of the accumulator in stacking direction. For this purpose, the outer walls can be respectively formed so as to be stepped on the end side in stacking direction, in such a way that successive outer walls in stacking direction lie against one another. Therefore, again, a simplified installation and production of the accumulator is possible. In particular, therefore a separate outer contour of the housing can be dispensed with.

Preferably, the interaction of the outer walls for forming the outer contour is realized in such a way that the outer contour is fluid-tight for the temperature-control fluid flowing through the channels.

Embodiments are conceivable in which noses, facing one another, of successive cell holders are spaced apart from one another. Therefore, the temperature-control fluid flowing through the associated channel can arrive at the associated accumulator cells and can therefore control their temperature, in particular cool them, directly and in an improved manner. Here, the accumulator cells can therefore delimit the channel which is able to be flowed through, and can therefore be in direct contact with the temperature-control fluid. It is preferred here if the accumulator cells have a fluid-tight outer casing.

The outer casing at least of one of the accumulator cells, preferably of the respective accumulator cell, advantageously has a projecting fold.

The fold can project in particular transversely to the stacking direction and can be arranged between the outer wall of the associated cell holder and an associated one of the noses. The arrangement of the fold between the nose and the outer wall permits a simple and stable fixing of the outer casing and therefore of the accumulator cell on the cell holder. Here, the fold can be applied for example in a materially bonded manner, in particular by soldering and/or welding and/or gluing, on the nose and/or on the outer wall.

Embodiments are preferred in which the fold has a clip-like or respectively clip-shaped end portion, preferably shaped in the manner of a paper clip. Advantageously, the end portion is arranged for fixing the fold between the nose and the outer wall. The clip-like shape of the fold is such that the end portion is, and/or leads to the end portion being, elastically deformable between the outer wall and the nose. This leads to the end portion and therefore the outer casing and the accumulator cell being fixed more securely in the cell holder and/or that thermal stresses can be better compensated.

The temperature-control fluid can be any desired temperature-control fluid. Air is to be considered here, so that the accumulator or respectively the accumulator cells are air-cooled.

Furthermore, a dielectric temperature-control fluid is conceivable. Therefore, electrical interactions between the temperature-control fluid and the accumulator cells and/or electrical connections of the accumulator are prevented or at least reduced. In particular, short-circuits and suchlike are therefore prevented, or the corresponding risk is at least reduced.

Basically it is conceivable to arrange respectively such a cooling plate between all successive accumulator cells in stacking direction.

Embodiments are also conceivable, in which a compressible intermediate element is arranged between at least two of the successive accumulator cells. With the intermediate element, a pressure equalization takes place and/or a compensation of thermally caused expansions and/or contractions of the accumulator, in particular of the cell holders, of the cooling plates and suchlike.

Embodiments are preferred, in which at least one of the intermediate elements is configured so as to be reversibly compressible, in particular is elastic. In particular, at least one of the intermediate elements can be formed as a cushion-like element, in particular as a cushion element.

Embodiments are advantageous, in which one such cooling plate and one such intermediate element are arranged in stacking direction between successive accumulator cells.

As mentioned above, the cell holders, with the corresponding holding structures, in particular the nose pairs, serve for holding the associated accumulator cells transversely to the stacking direction. The accumulator can, in addition, have a holding arrangement for holding the accumulator cells in stacking direction.

It is conceivable to provide the accumulator in stacking direction on the face side with pressure plates, of the holding arrangement, which hold the accumulator cells and/or the cell holders in stacking direction. For this, a tension band, acting on the pressure plates along the stacking direction, can be arranged around the pressure plates, in particular around the outer walls, for example around the outer contour, which tension band presses the pressure plates in the direction of the accumulator cells.

It is also conceivable to provide the accumulator with a tension anchor of the holding arrangement, which holds the accumulator cells and/or the cell holders in stacking direction. For this, projecting extensions can be provided on the respective cell holder and/or on the respective cooling plate.

The accumulator can basically be used in any desired application. The use of the accumulator in a vehicle is in particular to be considered.

Further important features and advantages of the invention will emerge from the subclaims, from the drawings and from the associated figure description with the aid of the drawings.

It shall be understood that the features mentioned above and to be explained further below are able to be used not only in the respectively indicated combination, but also in other combinations or in isolation, without departing from the scope of the present invention.

Preferred example embodiments of the invention are illustrated in the drawings and are explained further in the following description, wherein the same reference numbers refer to identical or similar or functionally identical components.

### BRIEF DESCRIPTION OF THE DRAWINGS

There are shown, respectively diagrammatically:

FIG. 1 an isometric view of an accumulator with accumulator cells and cell holders,

FIG. 2 a section through the accumulator,

FIG. 3 a section through the accumulator in another example embodiment,

FIG. 4 an isometric view of a cell holder of the accumulator of FIG. 3.

### DETAILED DESCRIPTION

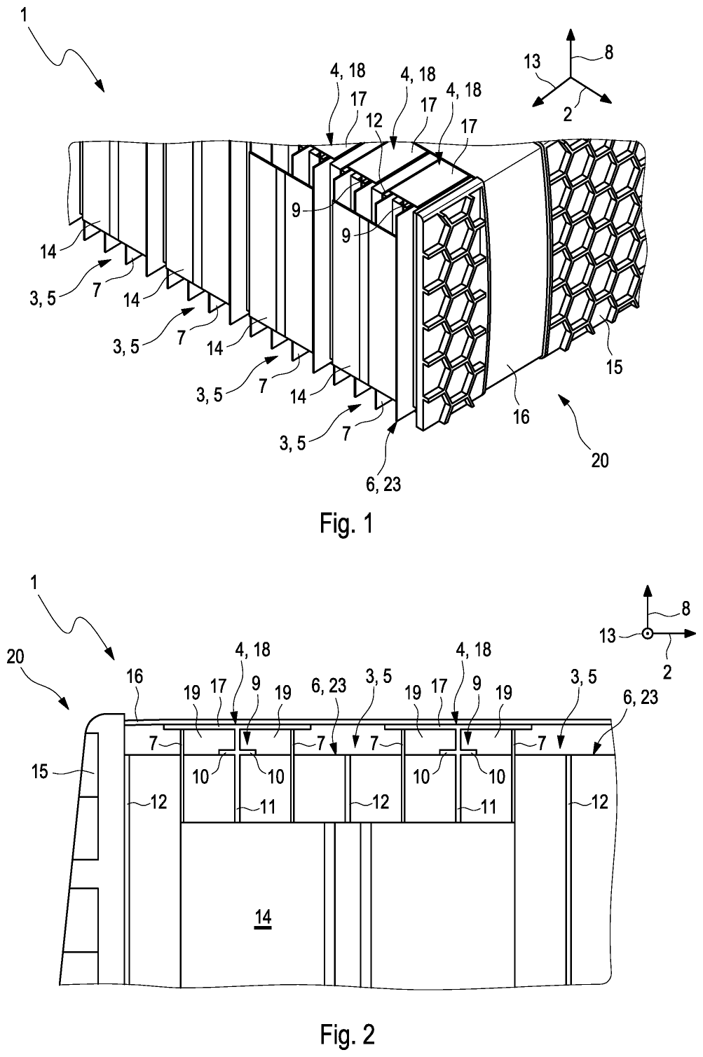

An accumulator 1, as can be seen for example in FIGS. 1 and 2, has several accumulator cells 3, arranged adjacent to one another in a stacking direction 2, and cell holders 4 for holding the accumulator cells 3. In FIG. 1, an isometric view of the accumulator 1 can be seen here, and in FIG. 2 a section through the accumulator 1 along the stacking direction 2. In the example which is shown, the accumulator cells 3 have respectively a cuboid-shaped basic form. The respective accumulator cell 3 is configured for example as a pouch cell 5. The accumulator cells 3 which are shown have respectively an outer casing 23, in particular a foil 6, in which a material (not shown) which is active for the electrical charging and discharging is received, wherein the outer casing 23 has a projecting fold 7. The accumulator cells 3 are held by the cell holders 4 in a vertical direction 8 running transversely to the stacking direction 2. The respective cell holder 4 holds here two accumulator cells 3 following one another in stacking direction 2. For this, the respective cell holder 4 has two nose pairs 9 which are spaced apart from one another in vertical direction 8, between which the associated accumulator cells 3 are held and of which only one is to be seen in FIGS. 1 and 2. The respective nose pair 9 has two noses 10, which are directed away from one another in stacking direction 2 and are projecting, wherein on the respective nose 10 of the respective nose pair 9 one of the associated accumulator cells 3 lies in vertical direction 8, so that the associated accumulator cells 3 are held in vertical direction 8 on the associated cell holder 4.

As can be seen in particular from FIG. 2, a cooling plate 11 is arranged between at least two of the accumulator cells 3 following one another in stacking direction 2, with which cooling plate these accumulator cells 3 are contacted in a heat-transferring manner. In the example which is shown, the accumulator cells 3 lie flat against the associated cooling plate 11. In the example which is shown, such a cooling plate 11 is arranged respectively here between the accumulator cells 3 which are held by the respective cell holder 4. Between the successive accumulator cells 3, which are held by different cell holders 4, a flat, plate-shaped intermediate element 12 is arranged, against which the accumulator cells 3 lie in a flat manner and which is aligned in vertical direction 8 with the associated accumulator cells 3. The intermediate element 2 is compressible, preferably reversibly, so that it can receive and compensate forces, in particular pressures, acting on the accumulator cells 3 along the stacking direction 2. In addition, the respective intermediate element 12 can compensate thermally caused movements, in particular expansions and contractions, within the accumulator 1.

As can be seen in particular from FIG. 1, the folds 7 of the accumulator cells 3 project over the cell halves both in vertical direction 8 and also in a widthwise direction 13 running transversely to the stacking direction 2 and transversely to the vertical direction 8. In the example which is shown, the respective accumulator cell 3 has a deflector 14, wherein in the example which is shown, respectively four of these deflectors 14 are connected with one another, in particular by welding.

In the accumulator 1 which is shown, the accumulator cells 3 and the cell holders 4 are held by two pressure plates 15 and a tension band 16 in stacking direction 2, wherein one of the pressure plates 15 can be seen in FIG. 1 and the other pressure plate 15 can be seen in FIG. 2. The pressure plates 15 are arranged in stacking direction 2 on the outer side of the accumulator 1, in such a way that the accumulator cells 3 are arranged between the pressure plates 15. The tension band 16 exerts a force onto the pressure plates 15 along the stacking direction 2 in such a way that the pressure plates 15, lying opposite one another, are pressed against one another and therefore hold the accumulator cells 3 and the cell holders 4 in stacking direction 2. The pressure plates 15 therefore form together with the tension band 16 a holding arrangement 20 of the accumulator 1, which holds the accumulator cell 3 and the cell holders 4 in stacking direction 2. As can be seen for example from FIG. 2, between the respective pressure plate 15 and the adjacent accumulator cell 3 in stacking direction 2, preferably one such intermediate element 12 is arranged here.

The respective cell holder 4 has advantageously an outer wall 17 on the end side in vertical direction 8, which extends along the stacking direction 2, wherein in the example which is shown the outer walls 17 run substantially parallel to the noses 10 of the associated cell holder 4. In the example, the respective cell holder 4 has such an outer wall 17 on both sides in vertical direction 8. The respective outer wall 17 serves in particular as a bearing surface of the accumulator 1, with which the accumulator 1 can rest on an adjacent object, which is not shown. In the example which is shown, the tension band 16 runs here along the outer wall 17 of the respective cell holder 4 and lies flat against the outer wall 17.

It can be seen furthermore that the respective cell holder 4 is produced in one piece and monolithically with the outer walls 17 and with the nose pairs 9 and with the cooling plate 11, which is arranged between the associated accumulator cells 3. Preferably, the respective cell holder 4 is produced as a profile body from a metal or a metal alloy, in particular from aluminium. The cooling plate 11 extends here up to the outer wall 17, in such a way that the noses 10 of the respective nose pair 9 project from the cooling plate 11. Therefore, the nose pair 9 and the adjacent outer wall 17 form, with the cooling plate 11 on the respective side of the associated accumulator cells 3, a double-T profile.

As can be seen in particular from FIG. 2, such a nose pair 9 is arranged between the respective outer wall 17 and the associated accumulator cells 3 of the respective cell holder 4, wherein the nose pair 9 and the outer wall 17 are spaced apart from one another in vertical direction 8. It can be seen, furthermore, that the folds 7 of the associated accumulator cells 3 on the side of the outer wall 17 facing the accumulator cells 3 abut the outer wall 17 and lie against the latter. Through the spaced-apart arrangement of the respective nose pair 9 to the adjacent outer wall 17, a channel 19 is formed between these, which in the example which is shown is divided in stacking direction 2 by the cooling plate 11 and is delimited by the folds 7. The respective channel 19 is delimited in vertical direction 8 by the outer wall 17 and, because the noses 10 are spaced apart from one another by cell holders 4 following one another in stacking direction 2, is delimited by one of the cell halves 6 of the associated accumulator cell 3. A temperature-control fluid, for example air or a temperature-control liquid, flows through the respective channel 9 during operation, in order to control the temperature of the accumulator cells 3, in particular to cool them. Here, the temperature-control fluid exchanges heat directly with the accumulator cells 3 and via the cooling plate 11 and via the channel 19 directly, and therefore controls the temperature thereof.

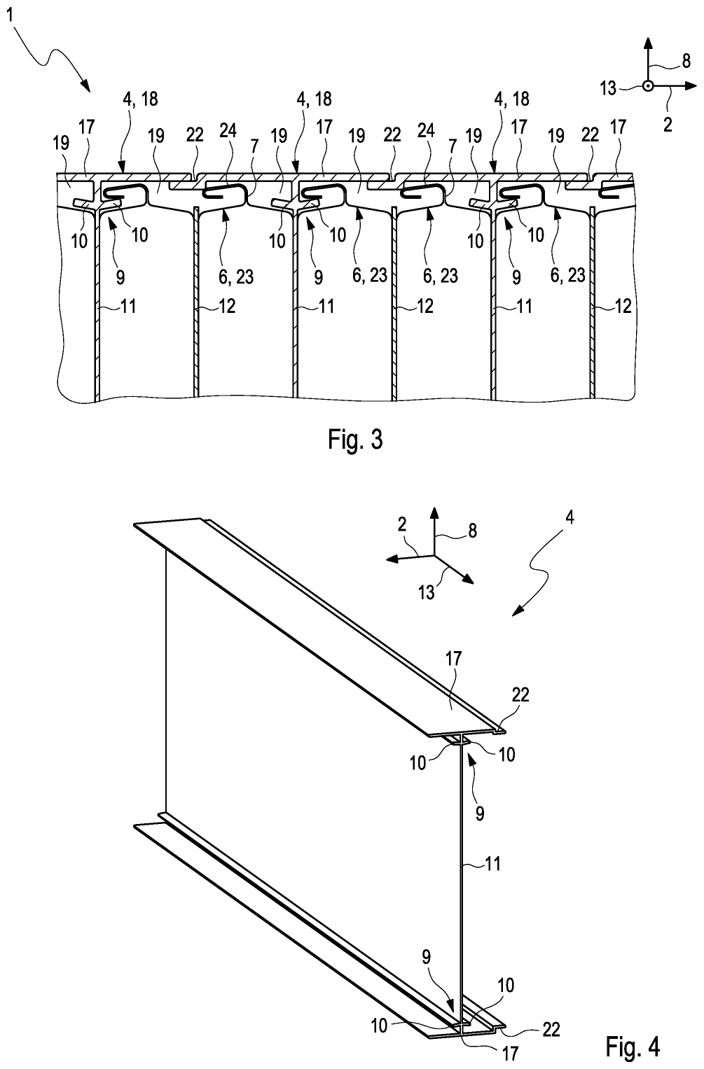

FIG. 3 shows a section through the accumulator 1 in another example embodiment. This example embodiment differs from the example shown in FIGS. 1 and 2 in particular in that the outer walls 17 of the cell holders 4 which follow one another in stacking direction 2 form an outer contour 21 of the accumulator 1, which is formed so as to be closed in stacking direction 2 and in widthwise direction 13. For this, the outer walls 17 which follow one another in stacking direction 2 lie against one another. In the example which is shown, there is an overlap in stacking direction 2 and in widthwise direction 13 between the outer walls 17 which follow one another in stacking direction 2. For this purpose, the respective outer wall 17 is provided in stacking direction 2 on one side with a shoulder 22, wherein the outer wall 17 of the adjacent cell holder 4 in stacking direction 2 rests on this shoulder 22, in order to form the closed outer contour 21. The outer contour 21 is, in addition, largely tight for the temperature-control fluid, so that the latter remains within the formed channels 19. The fold 7 of the outer casing 23 of the respective accumulator cell 3 projects here in vertical direction 8 and is folded over so that it has, on the end side, a clip-shaped end portion 24. The end portion 24 of at least one of the folds 7 is arranged here between an associated one of the noses 10 and the associated outer wall 17, in such a way that the outer wall 17 and the nose 10 together fix the fold 7 in vertical direction 8. Alternatively or additionally the folds 7 can be arranged on the associated nose 10 and/or on the associated outer wall 17 in a materially bonded manner, for example by soldering and/or welding and/or gluing. The clip-shaped configuration of the end portion 24 here is such that the end portion can be deformed elastically in vertical direction 8. In the example embodiment which is shown, every other end portion 24 is arranged in stacking direction 2 between the associated outer wall 17 and one of the associated noses 10. In the example embodiment which is shown, the folds 7 are folded over respectively in stacking direction 2 with the same orientation, therefore have end portions 24 pointing in the same direction. Of course, the folds 7 can also be folded over in a mirror-inverted manner and can therefore have end portions 24 which point in stacking direction 2 in the other direction. It is also clear that the folds 7 may not all be folded over in the same direction. Therefore, end portions 24 can be provided, which face one another in stacking direction 2.

In the example embodiment shown in FIG. 3, in addition the noses 10 of the respective nose pair 9 are directed away from the associated accumulator cell 3 in vertical direction 8, in order to prevent or at least reduce damage to the outer casing 23. The clip-shaped end portions 24 of the outer casings 23 lie alternately against the side of the associated nose 10, facing the outer wall 17, and the side of the shoulder 22 facing the accumulator cell 3. The channels 19 are therefore separated from one another in stacking direction 2 by the cell holders 4, in particular by the cooling plate 11 of the respective cell holder 4.

In FIG. 4 an isometric view of one of the cell holders 4 of FIG. 3 can be seen, in which the flat, planar form of the cooling plate 11 and the nose pairs 9, projecting therefrom, and outer walls 17 can be seen, wherein respectively a nose pair 8 and the adjacent outer wall 17 in vertical direction 8 form a double-T profile with the cooling plate 11.

What is claimed is:

1. An accumulator comprising:
a plurality of accumulator cells arranged adjacent to one another in a stacking direction;
a plurality of cell holders for holding the accumulator cells, each cell holder holding two successive accumulator cells; and
a cooling plate arranged between and in heat-transferring contact with the two successive accumulator cells.

2. The accumulator according to claim 1, wherein the cooling plate is produced in one piece with the cell holder holding the associated accumulator cells.

3. The accumulator according to claim 1, wherein the cooling plate lies flat against at least one of the associated accumulator cells.

4. The accumulator according to claim 1, wherein the cooling plate projects over the associated accumulator cells.

5. The accumulator according to claim 1, wherein at least one of the cell holders has at least one nose pair with two noses, which project in opposite directions and hold the associated accumulator cells transversely to the stacking direction.

6. The accumulator according to claim 5, wherein at least one of the cell holders has two nose pairs, which are spaced apart from one another transversely to the stacking direction.

7. The accumulator according to claim 1, wherein at least one of the cell holders has an outer wall spaced apart from the associated accumulator cells transversely to the stacking direction, which extends along the stacking direction.

8. The accumulator according to claim 5, wherein at least one of the cell holders has an outer wall spaced apart from the associated accumulator cells transversely to the stacking direction, which extends along the stacking direction.

9. The accumulator according to claim 8, wherein the at least one nose pair is arranged between the associated accumulator cells and the outer wall and spaced apart from the outer wall in such a way that a channel is formed between the nose pair and the outer wall.

10. The accumulator according to claim 7, wherein:
at least two cell holders following one another in the stacking direction, each including the outer wall; and
the outer walls of the at least two cell holders together form an outer contour which is closed in the stacking direction.

11. The accumulator according to claim 5, wherein:
at least two cell holders following one another in the stacking direction each has the nose pair; and
the noses, facing one another, the at least two cell holders spaced apart with respect to one another.

12. The accumulator according to claim 8, wherein:
the accumulator cells each has an outer casing, in which a material is received which is active for electrical charging and discharging;
at least one outer case has a fold projecting in a direction of an associated outer wall; and,
the fold has a clip-shaped end portion, which is arranged between the associated outer wall and an associated nose, in such a way that the associated nose and the associated outer wall fix the fold transversely to the stacking direction.

13. The accumulator according to claim 1, further comprising a compressible intermediate element arranged between at least two of the successive accumulator cells.

14. The accumulator according to claim 1, further comprising a holding arrangement for holding the accumulator cells in the stacking direction.

15. An accumulator comprising:
a plurality of accumulator cells arranged adjacent to one another in a stacking direction;
a plurality of cell holders for holding the accumulator cells, each cell holder holding two successive accumulator cells; and
a cooling plate arranged between and in heat-transferring contact with the two successive accumulator cells;
wherein at least one of the cell holders has at least one nose pair with two noses, which project in opposite directions and hold the associated accumulator cells transversely to the stacking direction; and
wherein at least one of the cell holders has an outer wall spaced apart from the associated accumulator cells transversely to the stacking direction, which extends along the stacking direction.

16. The accumulator according to claim 15, wherein at least one of the cell holders has two nose pairs, which are spaced apart from one another transversely to the stacking direction.

17. The accumulator according to claim 15, wherein the at least one nose pair is arranged between the associated accumulator cells and the outer wall and spaced apart from the outer wall in such a way that a channel is formed between the nose pair and the outer wall.

10. The accumulator according to claim 7, wherein:
at least two cell holders following one another in the stacking direction, each including the outer wall; and
the outer walls of the at least two cell holders together form an outer contour which is closed in the stacking direction.

18. The accumulator according to claim 15, wherein:
at least two cell holders following one another in the stacking direction each has the nose pair; and
the noses, facing one another, the at least two cell holders spaced apart with respect to one another.

19. The accumulator according to claim 15, wherein:
the accumulator cells each has an outer casing, in which a material is received which is active for electrical charging and discharging;
at least one outer case has a fold projecting in a direction of an associated outer wall; and,
the fold has a clip-shaped end portion, which is arranged between the associated outer wall and an associated nose, in such a way that the associated nose and the associated outer wall fix the fold transversely to the stacking direction.

20. The accumulator according to claim 15, wherein the cooling plate is produced in one piece with the cell holder holding the associated accumulator.
